(19) United States
(12) Patent Application Publication
(10) Pub. No.: US 2026/0289544 A1
(43) Pub. Date: Sep. 24, 2026

(54) METHOD AND SYSTEM OF PAYMENT TERMINAL DATA AUTOMATIC DOWNLOAD

(71) Applicant: SHENZHEN TOPWISE COMMUNICATION CO.,LTD., Shenzhen (CN)

(72) Inventors: QIHAN LIU, Shenzhen (CN); WEIQUAN OUYANG, Shenzhen (CN); WEIDE ZENG, Shenzhen (CN); XIANGYONG ZOU, Shenzhen (CN)

(21) Appl. No.: 19/307,773

(22) Filed: Aug. 22, 2025

(30) Foreign Application Priority Data
Mar. 21, 2025 (CN) 202510339752.9

(51) Int. Cl. G06Q 20/32

(52) U.S. Cl. CPC G06Q 20/3278; G06Q 20/3274

(57) ABSTRACT

A payment terminal data automatic download method is provided. The method includes the following steps: S1: configuring a mother terminal to be a simulation NFC tag card mode and electrically connecting it to a conveyor belt control device, and setting a child terminal to be a NFC card reader mode; S2: attaching identification information to the child terminal. If the child terminal is turned on and determines that SN and key information do not exist, it enters a download mode or triggers the download mode by pressing a button, and continues to send a card finding instruction. The payment terminal data automatic download method does not require an insertion of a data cable and adopts an NFC short-range transmission method. When the child terminal approaches the mother terminal, data transmission is achieved through NFC to download information, thereby saving the trouble of plugging and unplugging data cables.

### CROSS-REFERENCE TO RELATED APPLICATIONS

This application claims priority to Chinese Patent Application No. 202510339752.9, filed on Mar. 21, 2025, which is hereby incorporated by reference in its entirety.

### TECHNICAL FIELD

The present disclosure relates to the field of payment terminal technologies, and in particular, to a method and system of payment terminal data automatic download SN and Key.

### BACKGROUND

Payment terminals usually require downloading Service Number (SN) and key data information during a production process so as to function properly. The common method for downloading SN and keys during a production process of payment terminals is to connect a barcode scanner and payment terminal to a computer through a data cable. The SN barcode or Quick Response, (QR) code attached to the payment terminal device is scanned to a computer through the barcode scanner, and then downloaded to the payment terminal through a computer tool. This method of operation requires unplugging the data cable and plugging in the other device every time the device is replaced, which can be quite cumbersome.

### SUMMARY

To solve the above problems, this technical solution provides a method for a payment terminal to automatically download SN and keys.

To achieve the above objectives, this technical solution is as follows.

A payment terminal data automatic download method, including the following steps:
S1: configuring a mother terminal to be a simulation Near Field Communication, (NFC) tag card mode and electrically connecting it to a conveyor belt control device, and setting a child terminal to be an NFC card reader mode;
S2: attaching identification information to the child terminal; when the child terminal is turned on and determines that SN and key information do not exist, it enters a download mode or triggers the download mode by pressing a button, and continues to send a card finding instruction; where the identification information includes barcodes or QR codes;
S3: the mother terminal controls a conveyor belt to operate through the conveyor belt control device, so that the child terminal on the conveyor belt moves to a position corresponding to a scanning device; the scanning device automatically scans the identification information on the child terminal and transmits it to the mother terminal;
S4: the conveyor belt continues to work; when the child terminal approaches the mother terminal, the mother terminal responds to the card finding instruction of the child terminal and establishes a communication link, and controls the conveyor belt to stop;
S5: the mother terminal sends data in an NFC Data Exchange Format, (NDEF) format containing SN and key information to the child terminal;
S6: the child terminal completes a data reception and closes an NFC function;
S7: repeating steps S3-S6; or complete the step, the mother terminal controls the conveyor belt to stop.

The payment terminal data automatic download method further includes a computer end, the scanning device that is electrically connected to the computer end, where the mother terminal is electrically connected to the computer end.

The payment terminal data automatic download method, in step S3, the scanning device scans the identification information on the child terminal and transmits it to the computer end, and the computer end obtains corresponding SN and key information and transmits it to the mother terminal.

The payment terminal data automatic download method, where in step S5, the mother terminal converts the SN and key information into text format and encapsulates data in a NDEF format as simulation NFC tag card data, and the mother terminal starts entering the simulation NFC tag card mode and continues to monitor whether there is the card finding instruction.

The payment terminal data automatic download method, in step S6, the child terminal sends a card reading instruction to the mother terminal, and the mother terminal sends data that needs to be sent to the child terminal as response data to the child terminal. After receiving the data, the child terminal performs parsing processing, and the child terminal converts data that needs to be sent to the mother terminal into text that is encapsulated in the NDEF format and transmits it to the mother terminal through a card writing instruction. After receiving the card writing data, the mother terminal performs parsing processing.

The payment terminal data automatic download method, where in step S7, the mother terminal exits a simulation card mode after confirming that all information has been transmitted and sends an instruction to control the conveyor belt to continue rotating, and the child terminal closes the NFC function and exits the download mode after determining that all information has been received.

The payment terminal data automatic download method, where in step S7, when the mother terminal does not receive the identification information scanned by the scanning device within a preset time, the conveyor belt is controlled to stop.

The payment terminal data automatic download method, where processing steps of the child terminal include:
S01: entering a download mode;
S02: sending the card finding instruction;
S03: receiving a response to the card finding instruction, proceeding to a next step; otherwise, returning to step S02;
S04: entering an activation card mode;
S05: receiving activation feedback, proceeding to a next step; otherwise, returning to step S02;
S06: entering a card reading mode;
S07: receiving response feedback, proceeding to a next step; otherwise, returning to step S02;
S08: performing data processing and issuing read/write card instruction;
S09: receiving response feedback, proceeding to a next step; otherwise, returning to step S02;
S10: completing processing, completing the step; otherwise, returning to step S06.

The payment terminal data automatic download method, where processing steps of the mother terminal include:
S21: initialization;
S22: detecting whether there is SN and key information, proceeding to a next step; otherwise, repeating step S22;
S23: entering the simulation NFC tag card mode;
S24: receiving the card finding instruction, proceeding to a next step; otherwise, repeating step S24;
S25: responding to the card finding instruction and triggering the conveyor belt control device to stop the conveyor belt;
S26: receiving an activation command, proceeding to a next step; otherwise, repeating step S26;
S27: receiving response feedback;

S28: receiving the read/write card instruction, proceeding to a next step; otherwise, repeating step S28;
S29: performing data processing;
S30: completing processing, triggering the conveyor belt control device, starting the conveyor belt, completing the steps; otherwise, returning to step S28.

A payment terminal data automatic download system includes a computer end, the scanning device electrically connected to the computer end, the mother terminal electrically connected to the computer end, the conveyor belt control device electrically connected to the mother terminal, the conveyor belt electrically connected to the conveyor belt control device, and the child terminal.

The beneficial effects of this application are as follows.

The present disclosure provides the payment terminal data automatic download method, which does not require an insertion of a data cable and adopts NFC short-range transmission method. The mother terminal is simulated as an NFC tag card, and a card reader mode is used for the child terminal. When the child terminal approaches the mother terminal, data transmission is achieved through NFC to download information, which saves a trouble of plugging and unplugging data cables. Currently, payment devices generally have NFC function, and most NFC chips not only support card reading mode but have card simulation mode, so it will not increase costs.

### BRIEF DESCRIPTION OF DRAWINGS

In order to provide a clearer explanation of the technical solution in the embodiments of the present disclosure, a brief introduction will be given to the accompanying drawings required for the description of the embodiments.

FIG. 1 is a schematic diagram of a framework of an automated payment terminal data download system.

FIG. 2 is a flowchart of processing steps of a child terminal.

FIG. 3 is a flowchart of processing steps of a mother terminal.

### DESCRIPTION OF EMBODIMENTS

In order to render the technical problems, technical solutions, and beneficial effects solved by the present disclosure clearer and more understandable, the present disclosure will be further described in detail with reference to the accompanying drawings and embodiments. It should be understood that specific embodiments described herein are only used to explain the present disclosure and are not intended to limit the present disclosure.

A payment terminal data automatic download method, including the following steps:
S1: configuring a mother terminal to be a simulation NFC tag card mode and electrically connecting it to a conveyor belt control device, and setting a child terminal to be an NFC card reader mode;
S2: attaching identification information to the child terminal; when the child terminal is turned on and determines that SN and key information do not exist, it enters a download mode or triggers the download mode by pressing a button, and continues to send a card finding instruction; where the identification information includes barcodes or QR codes;
S3: the mother terminal controls a conveyor belt to operate through the conveyor belt control device, so that the child terminal on the conveyor belt moves to a position corresponding to a scanning device; the scanning device automatically scans the identification information on the child terminal and transmits it to the mother terminal;
S4: the conveyor belt continues to work; when the child terminal approaches the mother terminal, the mother terminal responds to the card finding instruction of the child terminal and establishes a communication link, and controls the conveyor belt to stop;
S5: the mother terminal sends data in an NDEF format containing SN and key information to the child terminal;
S6: the child terminal completes a data reception and closes an NFC function;
S7: repeating steps S3-S6; or complete the step, the mother terminal controls the conveyor belt to stop.

The present disclosure provides the payment terminal data automatic download method, which does not require an insertion of a data cable and adopts NFC short-range transmission method. The mother terminal is simulated as an NFC tag card, and a card reader mode is used for the child terminal. When the child terminal approaches the mother terminal, data transmission is achieved through NFC to download information, which saves the trouble of plugging and unplugging data cables. Currently, payment devices generally have NFC function, and most NFC chips not only support card reading mode but have card simulation mode, so it will not increase costs.

In an implementation mode, the payment terminal data automatic download method further includes a computer end, the scanning device that is electrically connected to the computer end, where the mother terminal is electrically connected to the computer end.

In an implementation mode, in step S3, the scanning device scans the identification information on the child terminal and transmits it to the computer end, and the computer end obtains corresponding SN and key information and transmits it to the mother terminal.

In an implementation mode, in step S5, the mother terminal converts the SN and key information into text format and encapsulates data in a NDEF format as simulation NFC tag card data, and the mother terminal starts entering the simulation NFC tag card mode and continues to monitor whether there is the card finding instruction.

In an implementation mode, in step S6, the child terminal sends the card reading instruction to the mother terminal, and the mother terminal sends data that needs to be sent to the child terminal as response data to the child terminal. After receiving the data, the child terminal performs parsing processing, and the child terminal converts data that needs to be sent to the mother terminal into text that is encapsulated in the NDEF format and transmits it to the mother terminal through a card writing instruction. After receiving the card writing data, the mother terminal performs parsing processing.

In an implementation mode, in step S7, the mother terminal exits the simulation card mode after confirming that all information has been transmitted and sends an instruction to control the conveyor belt to continue rotating, and the child terminal closes the NFC function and exits the download mode after determining that all information has been received.

In an implementation mode, in step S7, when the mother terminal does not receive the identification information scanned by the scanning device within a preset time, the conveyor belt is controlled to stop.

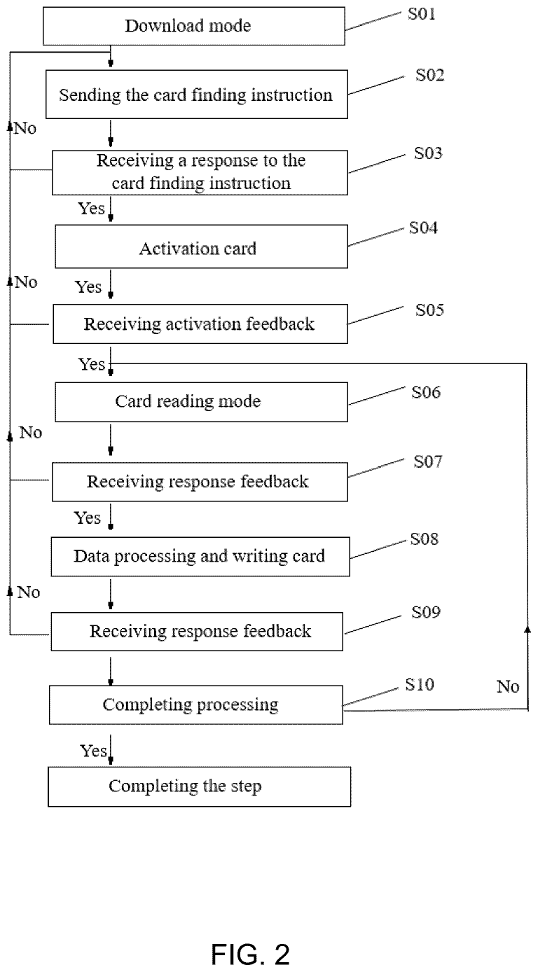

In an implementation mode, as shown in FIG. 2, processing steps of the child terminal include:
S01: Entering a Download Mode;
S02: sending the card finding instruction;
S03: receiving a response to the card finding instruction, proceeding to a next step; otherwise, returning to step S02;
S04: entering an activation card mode;
S05: receiving activation feedback, proceeding to a next step; otherwise, returning to step S02;
S06: entering a card reading mode;
S07: receiving response feedback, proceeding to a next step; otherwise, returning to step S02;
S08: performing data processing and issuing read/write card instruction;
S09: receiving response feedback, proceeding to a next step; otherwise, returning to step S02;
S10: completing processing, completing the step; otherwise, returning to step S06.

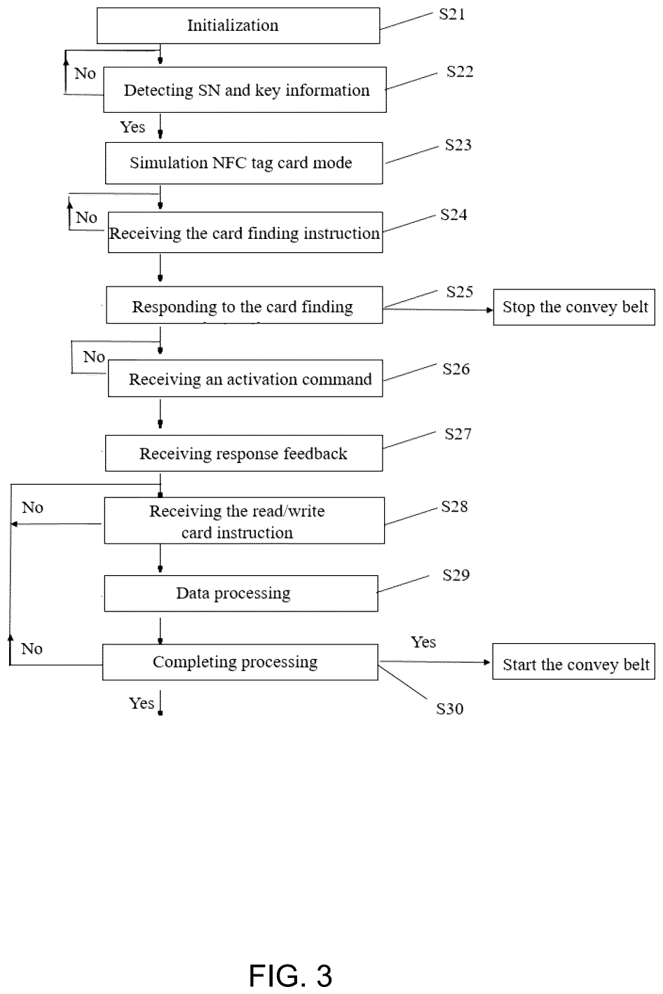

In an implementation mode, as shown in FIG. 3, processing steps of the mother terminal include:
S21: initialization;
S22: detecting whether there is SN and key information, proceeding to a next step; otherwise, repeating step S22;
S23: entering the simulation NFC tag card mode;
S24: receiving the card finding instruction, proceeding to a next step; otherwise, repeating step S24;
S25: responding to the card finding instruction and triggering the conveyor belt control device to stop the conveyor belt;
S26: receiving an activation command, proceeding to a next step; otherwise, repeating step S26;
S27: receiving response feedback;
S28: receiving the read/write card instruction, proceeding to a next step; otherwise, repeating step S28;
S29: performing data processing;
S30: completing processing, triggering the conveyor belt control device, starting the conveyor belt, completing the steps; otherwise, returning to step S28.

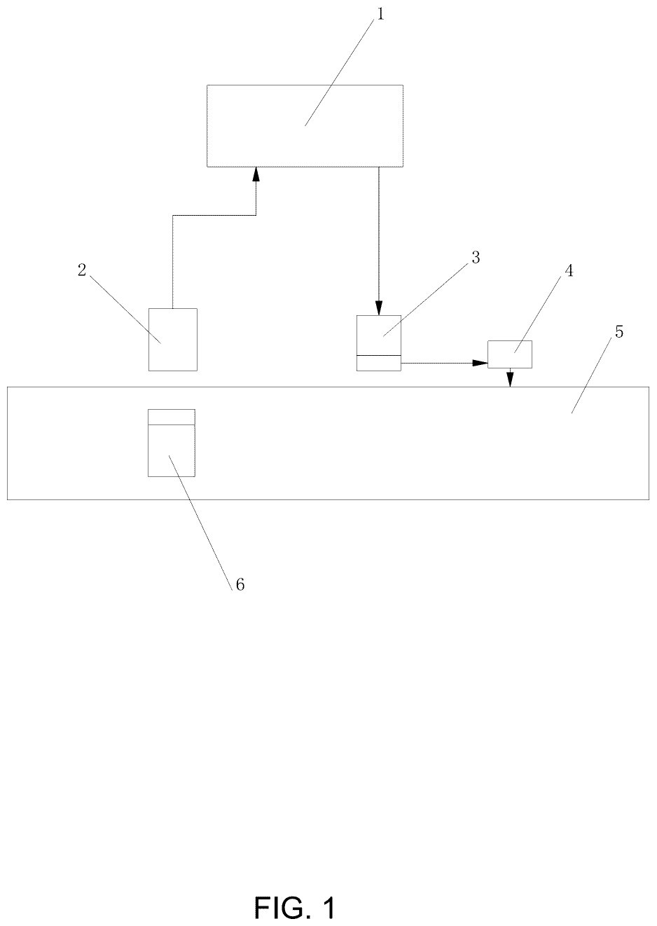

As shown in FIG. 1, a payment terminal data automatic download system includes a computer terminal 1, a scanning device 2 electrically connected to the computer terminal 1, a mother terminal 3 electrically connected to the computer terminal 1, a conveyor belt control device 4 electrically connected to the mother terminal 3, a conveyor belt 5 electrically connected to the conveyor belt control device 4, and a child terminal 6.

Working principle of this embodiment:
1. Finding a payment terminal with NFC function (called a child terminal) and an automatic scanning device (which can be a barcode scanner or a payment terminal with scanning function), and them are connected to a computer through data cables. As a card reader, the child terminal implements card simulation function on the mother terminal device, and the mother terminal device is connected to the conveyor belt control device.
2. Adding a function mode of downloading SN and key through NFC on the payment terminal (child terminal) that needs to download information. When the device is turned on, it will determine that the SN does not exist or press a certain button to enter this mode. In this mode, the child terminal will continuously send the card finding instruction through NFC to detect whether a simulation card from the mother terminal is approaching.
3. Placing the automatic scanning device and the mother terminal next to or above the conveyor belt on the production line, and adjust a position and an angle so that when the child terminal is transported to the scanning device, the scanning device can quickly and accurately scan content of the barcode or QR code. When the child terminal is transmitted to the front of the mother terminal, the child terminal can recognize a card simulated by the mother terminal.
4. After testing basic functions of the child terminal at a previous workstation during production, a barcode or QR code is pasted at the corresponding position of the child terminal, and the child terminal is allowed to enter a mode of downloading SN information through NFC. Then the child terminal is placed on the conveyor belt and the angle is adjusted.
5. When the child terminal is transmitted to the scanning device, the SN code information attached to the child terminal is scanned and transmitted to the computer tool. If a key needs to be downloaded, the tool sends the SN to a backend server to obtain the key information corresponding to the SN, and then transmits the SN and key information to the mother terminal. The mother terminal converts the data information into text format and encapsulates it in an NDEF format as card data of the simulation card. The mother terminal then enters a simulation card mode and monitors whether there is the card finding instruction.
6. When the child terminal approaches the mother terminal through the conveyor belt, the mother terminal responds to the card finding instruction. After receiving the response, the child terminal sends the instruction to further confirm whether the mother terminal simulation card has been detected and activated. After receiving an activation instruction, the mother terminal responds and sends an instruction to control the conveyor belt to stop moving and wait for the information download to be completed.
7. After establishing a data link between the child terminal and the mother terminal, the child terminal sends a card reading instruction to the mother terminal. The mother terminal sends the data that needs to be sent to the child terminal as response data to the child terminal. After receiving the data, the child terminal parses and processes it. The child terminal then converts the data that needs to be sent to the mother terminal into text that is encapsulated in the NDEF format and transmits it to the mother terminal through the card writing instruction. After receiving card writing data, the mother terminal parses and processes it. After confirming that all information has been transmitted, the mother terminal exits the simulation card mode and sends an instruction to control the conveyor belt to continue rotating. The child terminal closes NFC and exits the download mode after determining that all information has been received.
8. By repeating steps 4-7 through the above operations, automatic downloading of SN and key information can be achieved, thereby eliminating the trouble of plugging and unplugging data cables and saving labor costs.

The above description is only preferred embodiment of the present application and is not intended to limit the scope of implementation of the present application. Any other principles and basic structures that are the same or similar to those of the present application are within the protection scope of the present application.

What is claimed is:

1. A payment terminal data automatic download method, comprising the following steps:
S1: configuring a mother terminal to be a simulation Near Field Communication, (NFC) tag card mode and electrically connecting it to a conveyor belt control device, and setting a child terminal to be an NFC card reader mode;
S2: attaching identification information to the child terminal; when the child terminal is turned on and determines that SN and key information do not exist, it enters a download mode or triggers the download mode by pressing a button, and continues to send a card finding instruction; wherein the identification information comprises barcodes or Quick Response, (QR) codes;
S3: the mother terminal controls a conveyor belt to operate through the conveyor belt control device, so that the child terminal on the conveyor belt moves to a position corresponding to a scanning device; the scanning device automatically scans the identification information on the child terminal and transmits it to the mother terminal;
S4: the conveyor belt continues to work; when the child terminal approaches the mother terminal, the mother terminal responds to the card finding instruction of the child terminal and establishes a communication link, and controls the conveyor belt to stop;
S5: the mother terminal sends data in an NFC Data Exchange Format, (NDEF) format containing Service Number, (SN) and key information to the child terminal;
S6: the child terminal sends a card reading instruction to the mother terminal, and the mother terminal sends data that needs to be sent to the child terminal as response data to the child terminal, after receiving the data, the child terminal parses and processes it; the child terminal converts data that needs to be sent to the mother terminal into text that is encapsulated in the NDEF format, and transmits it to the mother terminal through a card writing instruction, after receiving card writing data, the mother terminal parses and processes it, after the child terminal completes a data reception, a NFC function is turned off;
S7: repeating steps S3-S6; or complete the step, the mother terminal controls the conveyor belt to stop;
wherein processing steps of the child terminal comprises:
S01: entering a download mode;
S02: sending the card finding instruction;
S03: receiving a response to the card finding instruction, proceeding to a next step;
otherwise, returning to step S02;
S04: entering an activation card mode;
S05: receiving activation feedback, proceeding to a next step; otherwise, returning to step S02;
S06: entering a card reading mode;
S07: receiving response feedback, proceeding to a next step; otherwise, returning to step S02;
S08: performing data processing and issuing read/write card instruction;
S09: receiving response feedback, proceeding to a next step; otherwise, returning to step S02;
S10: completing processing, completing the step; otherwise, returning to step S06;
wherein processing steps of the mother terminal comprises:
S21: initialization;
S22: detecting whether there is SN and key information, proceeding to a next step; otherwise, repeating step S22;
S23: entering the simulation NFC tag card mode;
S24: receiving the card finding instruction, proceeding to a next step; otherwise, repeating step S24;
S25: responding to the card finding instruction and triggering the conveyor belt control device to stop the conveyor belt;
S26: receiving an activation command, proceeding to a next step; otherwise, repeating step S26;
S27: receiving response feedback;
S28: receiving the read/write card instruction, proceeding to a next step; otherwise, repeating step S28;
S29: performing data processing;
S30: completing processing, triggering the conveyor belt control device, starting the conveyor belt, completing the steps; otherwise, returning to step S28.

2. The payment terminal data automatic download method according to claim 1, further comprises a computer end, the scanning device that is electrically connected to the computer end, wherein the mother terminal is electrically connected to the computer end.

3. The payment terminal data automatic download method according to claim 2, wherein in step S3, the scanning device scans the identification information on the child terminal and transmits it to the computer end, and the computer end obtains corresponding SN and key information and transmits it to the mother terminal.

4. The payment terminal data automatic download method according to claim 2, wherein in step S5, the mother terminal converts the SN and key information into text format and encapsulates data in a NDEF format as simulation NFC tag card data, and the mother terminal starts entering the simulation NFC tag card mode and continues to monitor whether there is the card finding instruction.

5. The payment terminal data automatic download method according to claim 1, wherein in step S7, the mother terminal exits a simulation card mode after confirming that all information has been transmitted and sends an instruction to control the conveyor belt to continue rotating, and the child terminal closes the NFC function and exits the download mode after determining that all information has been received.

6. The payment terminal data automatic download method according to claim 1, wherein in step S7, when the mother terminal does not receive the identification information scanned by the scanning device within a preset time, the conveyor belt is controlled to stop.

7. A payment terminal data automatic download system for implementing the payment terminal data automatic download method according to claim 1, wherein the payment terminal data automatic download system comprises a computer end, the scanning device electrically connected to the computer end, the mother terminal electrically connected to the computer end, the conveyor belt control device electrically connected to the mother terminal, the conveyor belt electrically connected to the conveyor belt control device, and the child terminal.
